(19) United States
(12) Patent Application Publication
(10) Pub. No.: US 2018/0316877 A1
(43) Pub. Date: Nov. 1, 2018

(54) Video Display System for Video Surveillance

(71) Applicant: SENSORMATIC ELECTRONICS, LLC, Boca Raton, FL (US)

(72) Inventor: Matthew Aloys Gruenke, Waltham, MA (US)

(21) Appl. No.: 15/967,997

(22) Filed: May 1, 2018

Related U.S. Application Data
(60) Provisional application No. 62/492,413, filed on May 1, 2017.
(60) Provisional application No. 62/492,557, filed on May 1, 2017.

(51) Int. Cl. H04N 5/272; H04N 5/232; G06K 9/62; G06T 7/73; H04N 7/18

(52) U.S. Cl. CPC H04N 5/272; H04N 5/23229; G06K 9/6202; G06T 2207/30232; H04N 7/181; G06T 2207/30244; G06T 7/74

(57) ABSTRACT

A video display system and method for displaying video data of a scene are disclosed. In an embodiment, the system includes a user device that captures image data of a scene, and video management system (VMS) that provides image data of the scene captured by one or more surveillance cameras. The user device renders the captured image data of the scene from the one or more surveillance cameras to be from a perspective of the user device. In one example, the user device is an augmented reality device for replaying image data from the cameras.

### RELATED APPLICATIONS

This application claims the benefit under 35 USC 119(e) of U.S. Provisional Application Nos. 62/492,413 and 62/492,557, both filed on May 1, 2017, both of which are incorporated herein by reference in their entirety.

### BACKGROUND OF THE INVENTION

Surveillance systems are used to help protect people, property, and reduce crime for homeowners and businesses alike and have become an increasingly cost-effective tool to reduce risk. These systems are used to monitor buildings, lobbies, entries/exits, and secure areas within the buildings, to list a few examples. The security systems also identify illegal activity such as theft or trespassing, in examples.

In these surveillance systems, surveillance cameras capture image data of scenes. The image data is typically represented as two-dimensional arrays of pixels. The cameras include the image data within streams, and users of the system such as security personnel view the streams on display devices such as video monitors. The image data is also typically stored to a video management system (VMS) for later access and analysis.

Users typically interact with the surveillance system via user devices. Examples of user devices include workstations, laptops, and personal mobile computing devices such as tablet or smart phone commodity computing devices, in examples. These user devices also have cameras that enable capturing of image data of a scene, and a display for viewing the image data.

The VMSs of these surveillance systems record frames of image data captured by and sent from one or more surveillance cameras/user devices, and can playback the image data on the user devices. When executing a playback of the image data on the user devices, the VMSs can stream the image data “live,” as the image data is received from the cameras, or can prepare and then send streams of previously recorded image data stored within the VMS for display on the user devices.

### SUMMARY OF THE INVENTION

Increasingly, user devices and some surveillance cameras are being fitted with depth resolving cameras or sensors in addition to the cameras that capture image data of the scene. These depth resolving cameras capture depth information for each frame of image data. Such a device can continuously determine its pose (position and orientation) relative to a scene, and provide its pose when requested.

In addition, some of the user devices having depth resolving cameras are also augmented reality devices. An augmented reality (AR) device is capable of continuously tracking its position and orientation within a finite space. One example of an AR device is the Hololens product offered by Microsoft Corporation. Another example is Project Tango.

Project Tango was an augmented reality computing platform, developed and authored by Google LLC. It used computer vision to enable user devices, such as smartphones and tablets, to detect their position relative to the world around the devices. Such devices can overlay virtual objects within the real-world environment, such that they appear to exist in real space.

AR devices generate visual information that enhances an individual's perception of the physical world. The visual information is superimposed upon the individual's view of a scene. The visual information includes graphics such as labels and three-dimensional (3D) images, and shading and illumination changes, in examples.

When cameras and user devices are each capturing image data of a common scene, there are technical challenges associated with displaying image data captured by surveillance cameras on the user devices. One challenge is that on the user device, the image data from the cameras must be aligned to the user device's current view/perspective of the scene. While the pose of the user device is known, another challenge is that the pose of each surveillance camera that captured the image data is often unknown and must be determined. Once the pose of both the cameras and the user device are known, yet another challenge is that the surveillance cameras and the user devices generally use different coordinate systems to represent and render image data and visual information.

The proposed method and system overcomes these technical challenges. In an embodiment, the VMS of the system determines the pose of the surveillance cameras based on the image data sent from the cameras, and provides translation/mapping of the camera image data from a coordinate system of the surveillance cameras to a coordinate system of the user device. In this way, image data from the cameras can be displayed on the user device, from the perspective of the user device, and be within the coordinate system used by the AR device. This allows a user device such as an AR device to correctly render image data from the surveillance cameras, such that the camera image data appears on the display of the AR device in approximately the same location within the scene as it was originally recorded.

In an embodiment, the present system uses user devices such as AR devices for viewing surveillance camera footage, such as when an on-scene investigator wants to see what transpired at the site of an incident.

Assume one or more fixed surveillance cameras of unspecified location and orientation are continuously streaming video and depth information, in real-time, to the VMS. Further, assume the AR device is continuously transmitting its position, orientation, and video and depth to the VMS.

The proposed method and system enables the VMS to determine the orientation and location of the fixed cameras within the coordinate system used by the AR device. This allows the AR device to correctly visualize imagery from the surveillance cameras to appear in approximately the same space where it was recorded.

In general, according to one aspect, the invention features a method for displaying video of a scene. The method includes a user device capturing image data of the scene, and a video management system (VMS) providing image data of the scene captured by one or more surveillance cameras. The user device renders the captured image data of the scene from the one or more surveillance cameras to be from a perspective of the user device.

In embodiments, the user device obtains depth information of the scene and sends the depth information to the VMS. Further, the user device might create composite image data by overlaying the captured image data of the scene from the cameras upon the image data of the scene captured by the user device, and then display the composite image data on a display of the user device. It can be helpful to create a transformation matrix for each of the cameras, the transformation matrices enabling rendering of the captured image data of the scene from the one or more surveillance cameras to be from a perspective of the user device.

In one case, a transformation matrix for each of the cameras is created by the VMS. In other cases, they can be created by the user device.

For example, creating a transformation matrix for each camera can include receiving image data captured by the user device, extracting landmarks from the user device image data to obtain user device landmarks, and extracting landmarks from the image data from each camera to obtain camera landmarks for each camera, comparing the user device landmarks against the camera landmarks for each camera to determine matching landmarks for each camera, and using the matching landmarks for each camera to create the transformation matrix for each camera.

The matching landmarks for each camera can be used to create the transformation matrix for each camera. This might include determining a threshold number of matching landmarks and populating the transformation matrix with 3D locations from the matching landmarks, the 3D locations being expressed in a coordinate system of the camera and in corresponding 3D locations expressed in a coordinate system of the user device.

In general, according to one aspect, the invention features a system for displaying video of a scene. The system comprises a user device that captures image data of the scene and one or more surveillance cameras that capture image data from the scene. The user device renders the captured image data of the scene from the one or more surveillance cameras to be from a perspective of the user device.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic and block diagram of a proposed video display system for displaying video of a scene, according to the present invention;

FIG. 2 is a block diagram showing components of the video display system and interactions between the components, where components such as surveillance cameras, an AR device as an example of a user device, and a video management system (VMS) are shown, and where various processes and components of the VMS for processing image data sent from the surveillance cameras and the AR device are also shown;

FIG. 3 is a flow chart showing a method of operation of the VMS, where the method stores image data and depth information sent from the surveillance cameras, extracts camera landmarks from the stored image data, and stores the camera landmarks for later analysis;

FIG. 4 shows detail for a camera input table of the VMS, where the table is populated with at least the image data and depth information obtained via the method of FIG. 3;

FIG. 5 is a schematic block diagram showing detail for how entries within a camera scene features table of the VMS are created, where each entry in the camera scene features table includes at least the camera landmarks extracted via the method of FIG. 3;

FIG. 6 is a flow chart showing another method of operation of the VMS, where the method extracts user device landmarks from image data sent to the VMS by the user device;

FIG. 7 is a schematic block diagram showing how entries within a user device scene features table of the VMS are created, where each entry in the table includes at least the user device landmarks extracted via the method of FIG. 6;

FIG. 8 is a flow chart showing yet another method of operation of the VMS, where the method shows how the VMS creates camera-specific 3D transformation matrices from the camera landmarks and the user device landmarks, and then provides the image data from the cameras along with the camera-specific transformation matrices to the user device; and

FIG. 9 is a flow chart showing a method of operation for a rendering pipeline executing on the user device.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

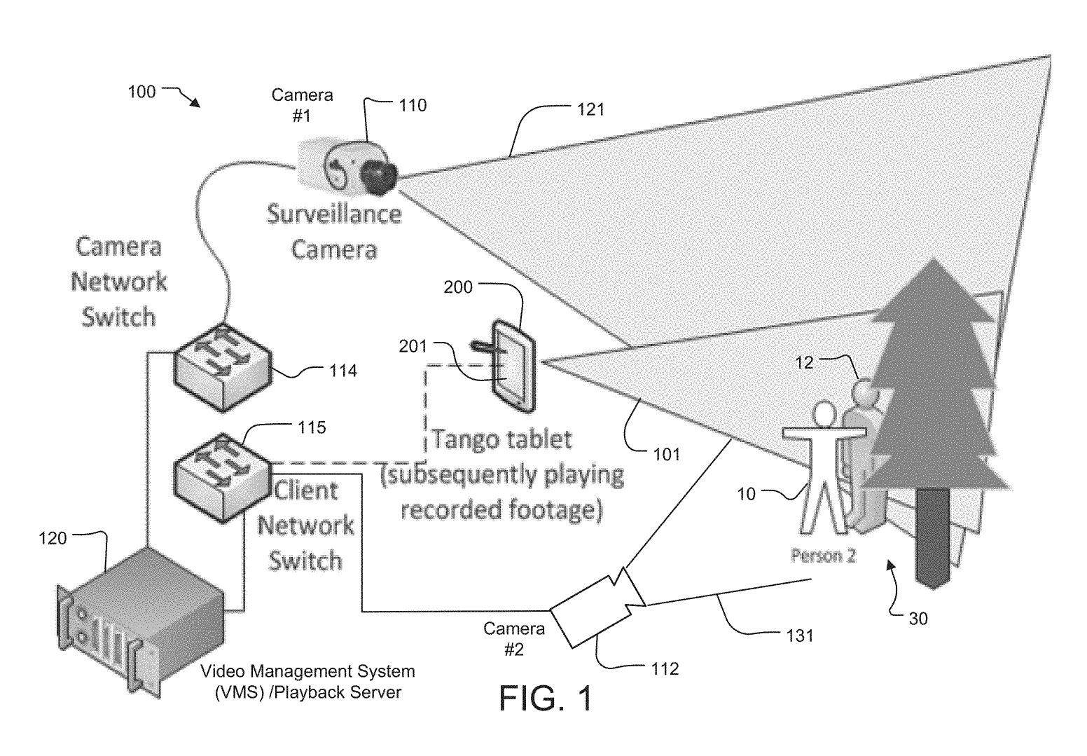

FIG. 1 shows a video display system 100 which has been constructed according to the principles of the present invention.

The system 100 includes various components. These components include surveillance cameras 110, 112, data communications switches 114/115, a video management system (VMS) 120, and a user device 200. In the illustrated example, the user device 200 is an AR device such as Tango tablet, as shown.

In the illustrated example, the user device 200 and the cameras 110, 112 are focused upon a common scene 30. The user device 200 captures image data of the scene 30, and the VMS 120 provides image data of the scene 30 captured by one or more surveillance cameras 110, 112. Then, the user device renders the captured image data of the scene 30 from the one or more surveillance cameras 110, 112 to be from a perspective of the user device. The user device then displays the image data on its display screen 201.

In more detail, camera network switch 114 connects and enables communications between surveillance camera 110 and the VMS 120. Client network switch 115 connects and enables communications between surveillance camera 112 and the VMS 120, and between the VMS 120 and the user device 200.

Typically, the surveillance cameras 110, 112 communicate with other components using data communications protocols such as internet-protocol (IP)/Ethernet based protocols. However, proprietary communications protocols can also be used.

The user device 200 has a depth-resolving camera and a display screen 201. The user device 200 captures image data of the scene 30, within a field of view 101 of the user device 200. In one example, the user device 200 obtains depth information of the scene 30 and sends the depth information to the VMS 120.

In more detail, in the illustrated example, multiple surveillance cameras 110, 112 survey a common scene 30. Surveillance camera 110 is also referred to as camera #1, and surveillance camera 112 is also referred to as camera #2. In the illustrated example, the scene 30 contains two persons 10, 12 that are standing near a tree. Each camera 110, 112 has a different view of the scene 30, via field of view 121 and 131 of cameras 110 and 112, respectively. The surveillance cameras 110, 112 provide image data back to the VMS 120.

The surveillance cameras 110, 112 might also provide position information and real-time orientation information of their respective views of the scene 30. For example, if the surveillance cameras 110, 112 are pan zoom tilt cameras, then their current orientation information is provided along with the image data sent to the VMS 120.

The present system analyzes the image data and depth information sent from the cameras 110, 112 to enable subsequent playback of the image data on the user device 200. In the illustrated example, the user device 200 is a mobile computing device such as a tablet or smart phone computing device that implements the Tango platform. In this way, the device detects its orientation and specifically analyzes its view/perspective of the scene 30.

In one example, the surveillance cameras 110, 112 have previously gathered image data of the scene that included the two persons at 10, 12.

The view/perspective of the scene 30 that each surveillance camera 110, 112 and the user device 200 has is different. The perspective of the scene is determined by the position and location (i.e. pose) of each camera/user device.

The image data from the cameras is replayed on the user device 200. During this replay process, the user device 200 determines its orientation and specifically its view/perspective of the scene 30. It also receives the prior recorded image data from cameras 110, 112 that is served by the VMS 120. The user device 200 determines the surveillance cameras' orientations, in order to correctly display the video footage that was previously recorded. The user device 200 then overlays this image data from the cameras 110, 112 onto the current image data that the user device 200 captures of the scene 30. In this way, the prior movements of persons 10, 12 can be replayed on the user device 200 based on the current perspective of the user device 200.

The AR features of the user device 200 help define its current view of the scene 30. When the user device 200 is an AR device, the AR device often includes a SLAM system (Simultaneous Localization And Mapping). SLAM systems, often employed by such AR devices, typically make use of feature matching to help determine their pose. Additionally, the user device preferably as a depth resolving capability to determine the range to various points within its field of view, which is further used to determine pose. This can be accomplished with a depth resolving camera system such as a time-of-flight camera or structure-light/dot projection system. Still other examples use two or more cameras to resolve depth using binocular image analysis. In the present example, the AR device 200 matches against existing landmarks with known positions to instantaneously determine its own pose.

In short, the present system determines which surveillance cameras 110, 112 captured which footage or image data of the scene 30 in question, and then displays the footage to a user such as an inspector on the user device 200 so that the footage aligns with the user device's current view/perspective.

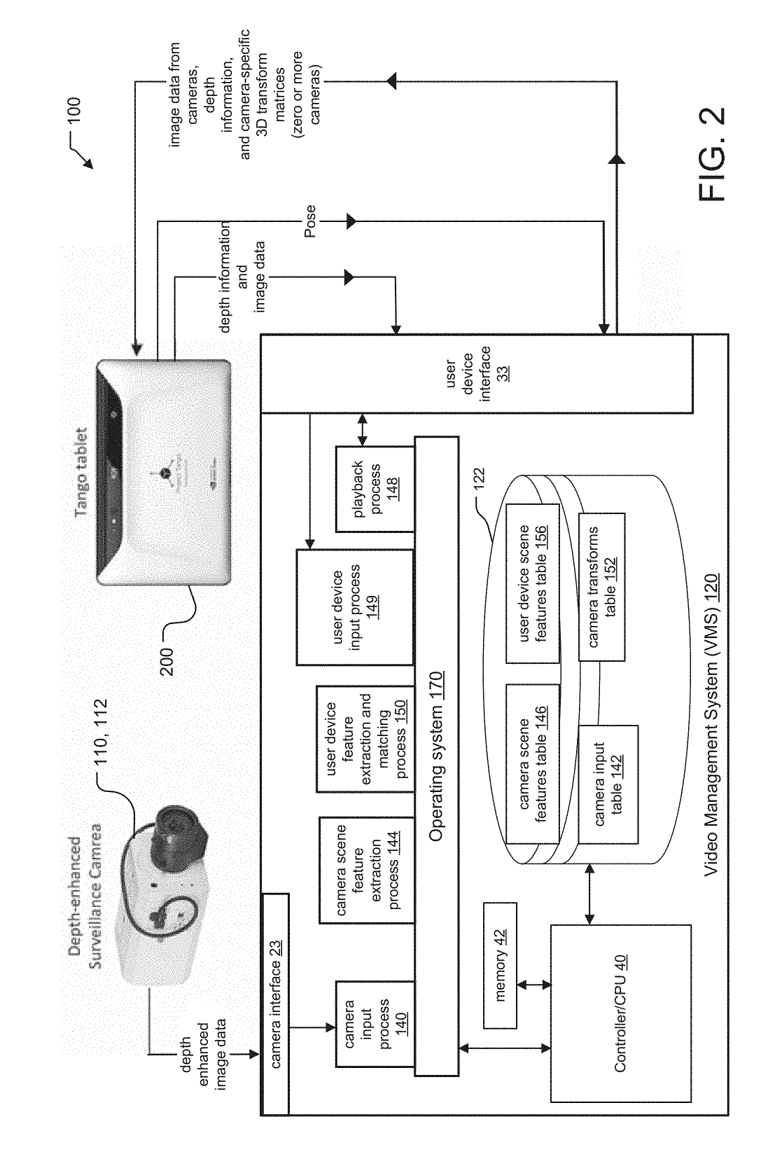

FIG. 2 shows more detail for the VMS 120. The figure also shows interactions between the VMS 120, surveillance cameras 110/112, and the user device 200 of the video management system 100.

The VMS 120 includes an operating system 170, a database 122, a controller 40, a camera interface 23, memory 42, and a user device interface 33. The controller 40 accesses and controls the operating system 170 and the database 122. In examples, the controller is a central processing unit (CPU) or a microcontroller.

Various applications or processes run on top of the operating system 170. The processes include a camera input process 140, a camera feature extraction process 144, a user device feature extraction and matching process 150, a user device input process 149, and a playback process 148.

The database 122 includes various tables that store information for the video display system 100. The tables include a camera scene features table 146, a camera input table 142, a user device scene features table 156, and a camera transforms table 152.

The camera input table 142 includes and stores information such as image data and depth information sent from the cameras 110, 112. The camera transforms table 152 includes information such as camera specific 3D transformation matrices.

Interactions between the VMS 120, surveillance cameras 110/112, and the user device 200 are also shown.

In more detail, the surveillance cameras 110, 112 have a function that enables the cameras to measure or estimate depth of the objects in the video and images that they provide to the VMS 120. The cameras 110, 112 provide their location and orientation information along with the current image data to the VMS 120 via its camera interface 23. The camera's lens parameters might also be known and are then sent to the VMS 120. In yet other example, the cameras 110, 112 further provide a current lens zoom setting with their image data to the camera interface 23.

More detail for some of the processes executing on top of the operation system 170 is included below.

The camera input process 140 accesses the camera interface 23, and stores the image data, depth information, and other camera-related information to the camera input table 142.

The user device input process 149 receives information sent from the user device 200 via the user device interface 33. This information includes depth information, image data, and pose of the user device 200. The user device input process 149 then stores this information to a buffer in the memory 42, in one implementation. In this way, the controller 40 and the processes can quickly access and execute operations upon the information in the buffer.

The playback process 148 provides various information to the user device 200 via the user device interface 33. The playback process 148 accesses stored information in the camera input table 142 such as image data and depth information from cameras 110, 112, and accesses camera-specific transformation matrices in the camera transforms table 152. The playback process 148 then sends the camera-specific transformation matrices and the image data and depth information from cameras 110, 112 to the user device 200.

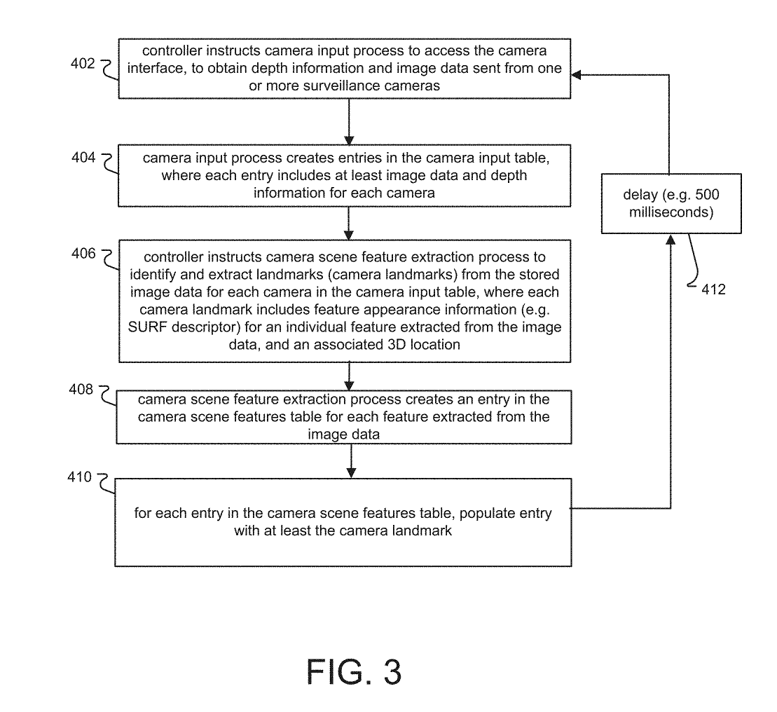

FIG. 3 illustrates a method of operation performed by the VMS 120. Specifically, the method first shows how image data from the surveillance cameras 110, 112 is received at the VMS 120. This image data is then stored to the camera input table 142. Also, the image data can be accessed by the camera scene feature extraction process 144.

Specifically, the method first shows how the VMS 120 populates the camera input table 142 with information such as image data sent from the cameras 110, 112. The method then extracts camera landmarks from the stored image data, and populates the camera scene features table 146 with the camera landmarks.

According to step 402, the controller 40 instructs the camera input process 140 to access the camera interface 23 to obtain depth information and image data sent from one or more surveillance cameras 110, 112.

In step 404, the camera input process 140 creates entries in the camera input table 142. Each entry includes at least image data and camera coordinates for each camera 110, 112.

Then, in step 406, the controller 40 instructs the camera scene feature extraction process 144 to identify and extract landmarks from the stored image data for each camera in the camera input table 142. Because these landmarks are extracted from camera image data, the landmarks are also known as camera landmarks.

In one implementation, the camera scene feature extraction process 144 uses a visual feature extractor algorithm such as speeded up robust features, or SURF. The SURF algorithm generates a set of salient image features from captured frames of each unmapped surveillance camera 110, 112 stored in the camera input table 142. Each feature contains orientation-invariant feature appearance information, to facilitate subsequent matching. Each feature is combined with its 3D position (within the camera's local coordinate system), in order to form a camera landmark.

In step 408, the camera scene feature extraction process 144 creates an entry in the camera scene features table 146 for each feature extracted from the image data. Then, in step 410, the camera scene feature extraction process 144 populates each entry created in step 408.

According to step 410, for each entry in the camera scene features table 146, the camera scene feature extraction process 144 populates the entry with at least feature appearance information (e.g. SURF descriptor) and feature 3D location, expressed in camera coordinates. The pair of (feature appearance information, feature 3D location) form a camera landmark. In this way, these camera landmarks are stored as database records, on the VMS 120 at which the video from the cameras 110, 112 is being recorded.

Preferably, the camera landmarks are extracted from the image data from each surveillance camera 110, 112 at startup of the VMS 120, and then periodically thereafter. The relative frequency with which each is seen can be recorded and used to exclude from matching those camera landmarks found to be ephemeral or unstable. Such ephemeral or unstable landmarks likely correspond to foreground objects or dynamic background elements in the image data.

In step 412, the method waits for a time period before accessing another frame of image data. In one example, the delay is 500 milliseconds. However, in other examples, the delay can also be as small as 50 milliseconds, or be on the order of seconds. The method then transitions to step 402 to access the next frame of camera image data from the camera interface 23.

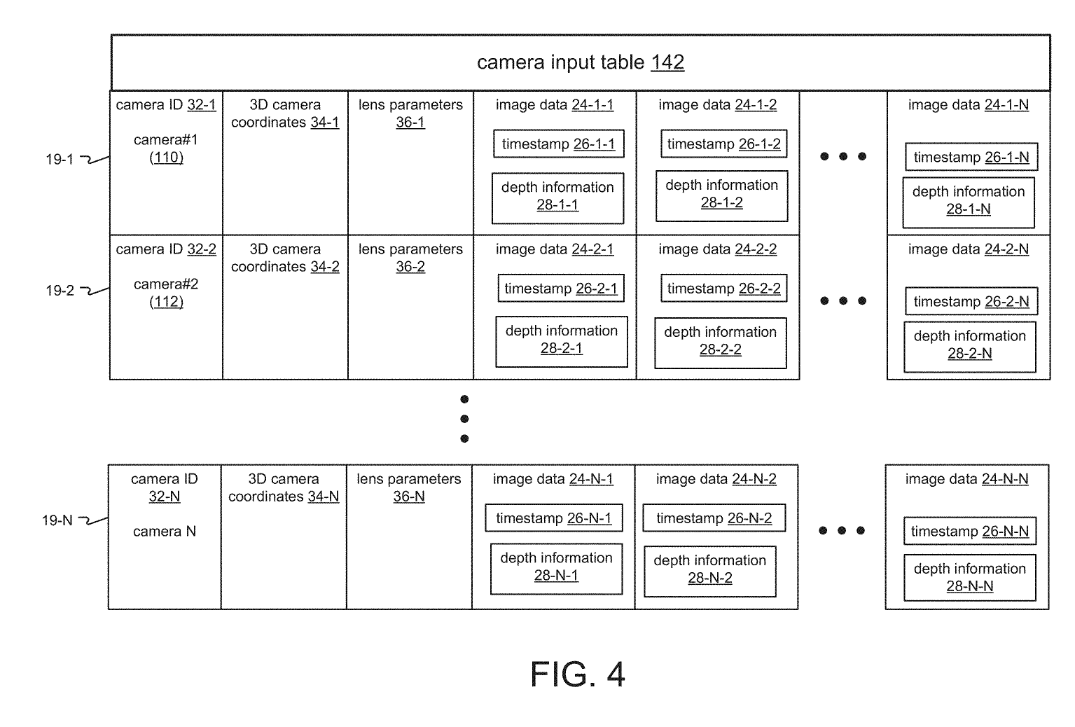

FIG. 4 shows detail for the camera input table 142. An entry 19 exists for each camera 110, 112.

Each entry 19 includes a camera ID 32, 3D camera coordinates 34, lens parameters 36, and one or more frames of image data 24. Each entry 19 is populated in accordance with the method of FIG. 3, described hereinabove.

In more detail, entry 19-1 includes information sent by camera 110. Here, the camera ID 32-1 is that of camera #1/110. The entry 19-1 also includes 3D camera coordinates 34-1, lens parameters 36-1, and frames of image data 24. Exemplary frames of image data 24-1-1, 24-1-2, and 24-1-N are shown. Each frame of image data 24-1-N also includes a timestamp 26-1-N and depth information 28-1-N associated with that frame of image data 24-1-N. The depth information, in one example, is a range for each pixel or pixel group within the images.

In a similar vein, entry 19-2 includes information sent by camera 112. Here, the camera ID 32-2 is that of camera #2/112. The entry 19-2 also includes 3D camera coordinates 34-2, lens parameters 36-2, and frames of image data 24. Exemplary frames of image data 24-2-1, 24-2-2, and 24-2-N are shown.

The 3D camera coordinates 34 and timestamps 26 of the image data are used internally, in service of finding and maintaining an accurate estimate of the surveillance camera's position and orientation.

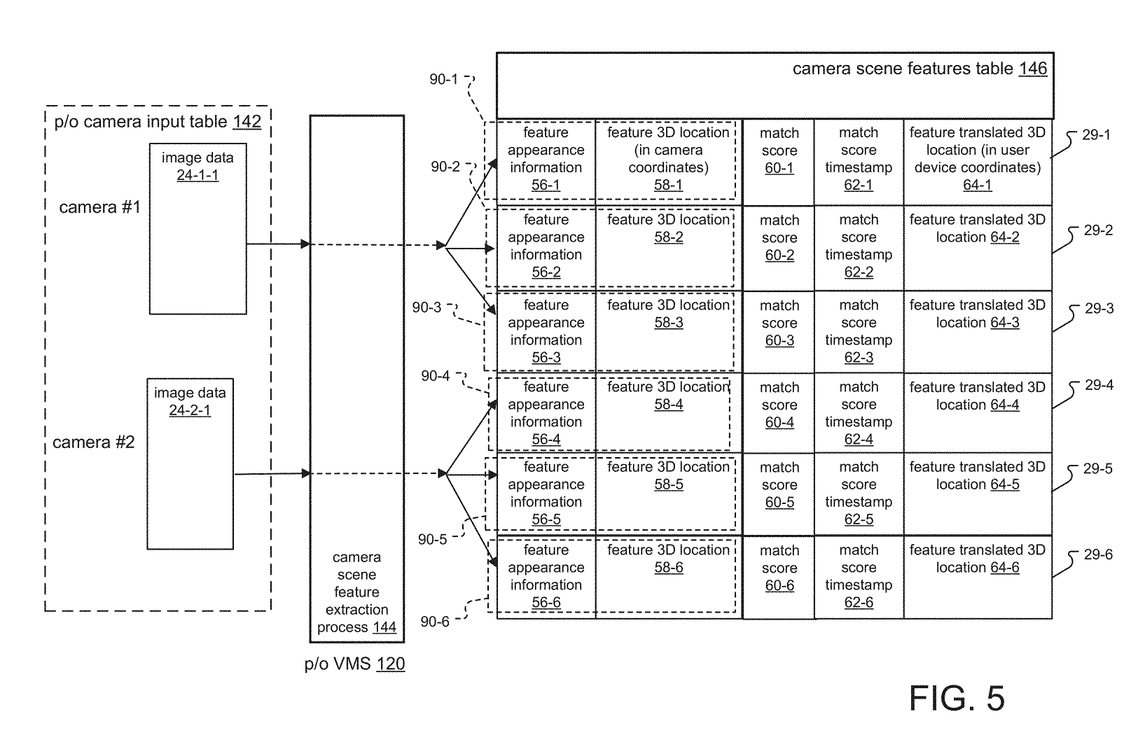

FIG. 5 illustrates how the camera scene feature extraction process 144 creates entries 29 within the camera scene features table 146. Each entry 29 includes at least camera landmarks 90, which were extracted and populated via the method of FIG. 3.

In more detail, each entry 29 includes fields such as feature appearance information 56 (e.g. SURF descriptor), a feature 3D location 58 a match score 60, a match score timestamp 62, and a feature translated 3D location 64. The feature 3D location 58 is expressed in the camera's coordinate system, while the feature translated 3D location 64 is expressed in a coordinate system of the user device 200. The pair of (feature appearance information 56, feature 3D location 58) for each entry 29 forms a camera landmark 90.

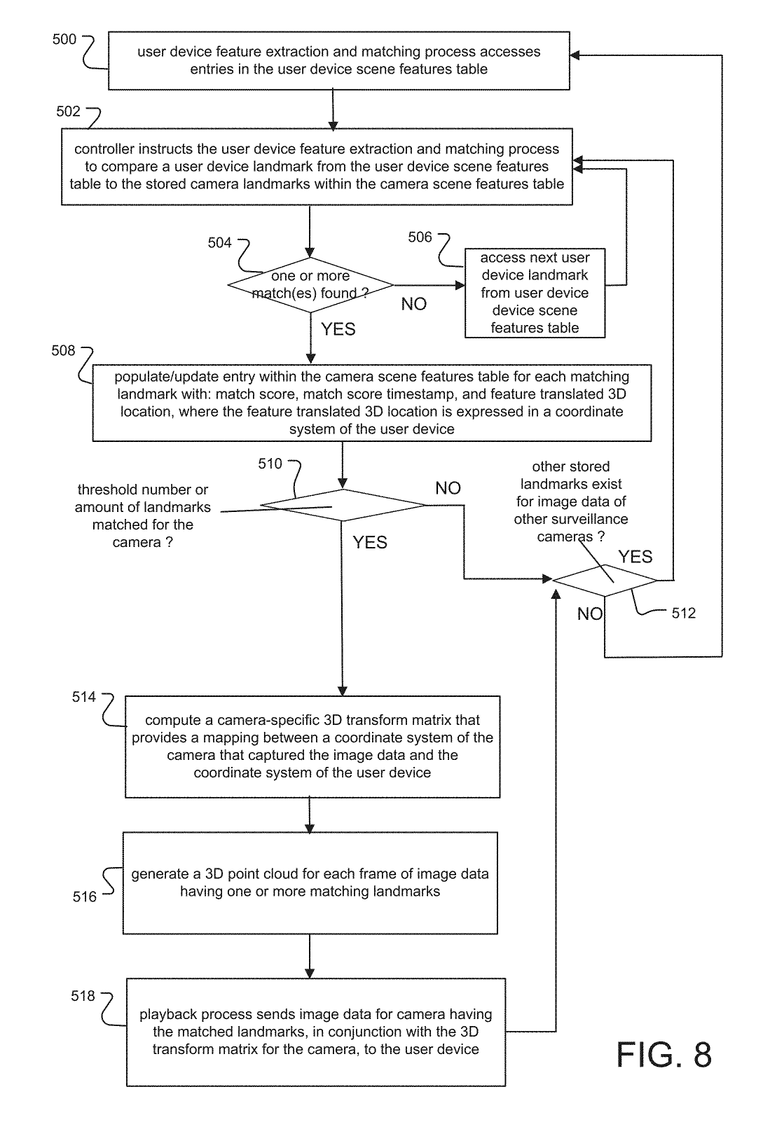

The match score 60 is a best match score (if any) from the view/perspective of the user device 200 for the same feature stored in the feature appearance information 56. The match score timestamp 62 indicates the time of the match (if any) when comparing the user device's view of the same feature (i.e. user device landmark) to the corresponding camera landmark 90. The 3D location at which the match was observed is stored in the feature translated 3D location 64, expressed using the AR device's coordinate system. More information concerning how the VMS 120 populates these match-related fields in the camera scene features table 146 is disclosed in the description accompanying FIG. 8, included hereinbelow.

In the illustrated example, the camera scene feature extraction process 144 is shown accessing exemplary frames of image data 24-1-1 and 24-2-1 from the entries 19 of the camera input table 142 in FIG. 4. In accordance with the method of FIG. 3, the camera scene feature extraction process 144 creates entries 29 in the camera scene features table 146. Exemplary entries 29-1 through 29-6 are shown.

Here, the camera scene feature extraction process 144 has identified and extracted three separate camera landmarks 90-1 through 90-3 from frame of image data 24-1-1. In a similar vein, the process 144 has identified and extracted three separate camera landmarks 90-4 through 90-6 from frame of image data 24-2-1.

In one example, entry 29-1 includes feature appearance information 56-1, a feature 3D location 58-1, a match score 60-1, a match score timestamp 62-1, and a feature translated 3D location 64-1. Camera landmark 90-1 is formed from the feature appearance information 56-1 and the feature 3D location 58-1.

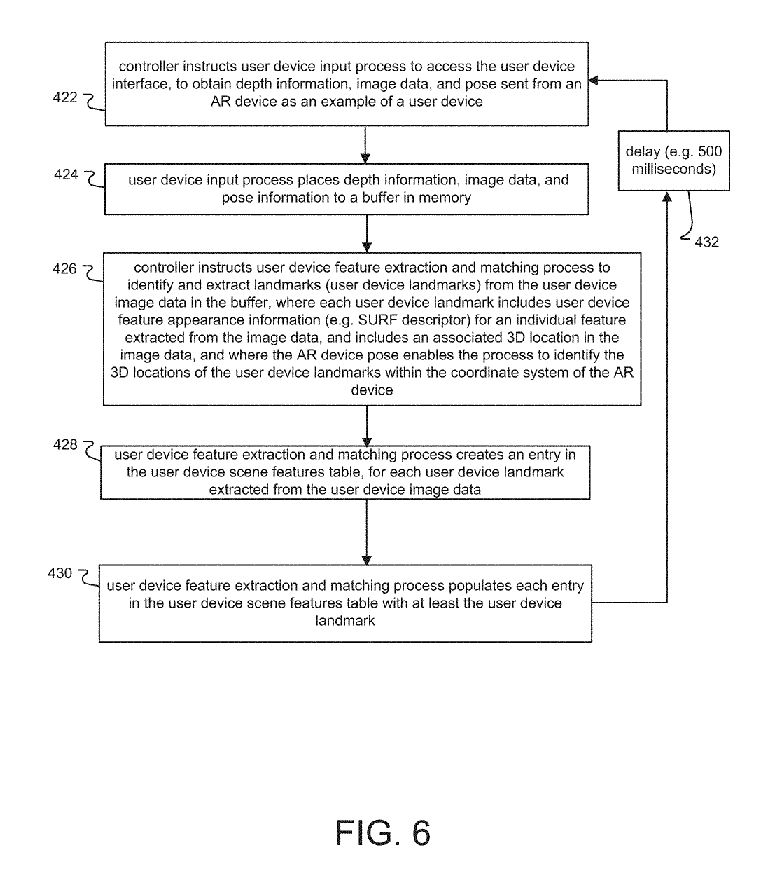

FIG. 6 is a flow chart showing another method of operation of the VMS 120.

Specifically, the method first shows how the VMS 120 accesses image data and depth information captured by and sent from the user device 200 to the VMS 120. The method then extracts user device landmarks from the received image data, and populates the user device scene features table 156 with at least the user device landmarks.

When the image data from the cameras is to be viewed on the augmented reality user device 200, the device 200 provides depth information and video frames to the VMS 120. On the VMS 120, the user device feature extraction and matching process 150 operates on the image data and information from the user device 200. The user device's pose and the depth-augmented video frames are used by the VMS to compute the locations of the visual features within its world coordinates, since being able to figure out where these features are is an important feature.

The feature matching process 150 creates the estimated per-camera 3D transformation matrices and stores them to the camera transforms table 152 in the database 122. The 3D transformation matrices allow the image data from the cameras 110, 112 to be transformed, on the user device 200, into the current perspective of the user device 200.

The playback process 148 sends the video with depth information, along with the 3D transform matrices from the one or more cameras to the AR device 200. The preferred approach is for the VMS to stream video from a surveillance camera with an estimated 3D transformation matrix that enables mapping of the image data in the video stream at the AR device 200 into the world coordinates of the AR device. The AR device then uses its current pose to further transform that geometry to match its view. Thus, the VMS 120 provides one piece of the ultimate transformation of the image data from the cameras, while the AR device can locally compute the other, in one embodiment.

According to step 422, the controller 40 instructs the user device input process 149 to access the user device interface 33, to obtain depth information, image data, and a pose sent from the user device 200. Here, the user device 200 is an AR device.

In step 424, the user device input process 149 places the depth information, the image data, and pose from the AR device to a buffer in memory 42. This enables fast access to the information by other processes and the controller 40. This information could also be stored to a separate table in the database 122, in another example.

Then, in step 426, the controller 40 instructs the user device feature extraction and matching process 150 to identify and extract landmarks from the user device image data. Because these landmarks are extracted from user device image data, the landmarks are also known as user device landmarks. Each user device landmark includes user device feature appearance information (e.g. SURF descriptor) for an individual feature extracted from the image data, and an associated user device feature 3D location. The pose received from the user device 200/AR device enables the user device feature extraction and matching process 150 to identify the 3D locations/positions of the user device landmarks within the coordinate system of the user device 200/AR device.

In step 428, the process 150 creates an entry in the user device scene features table 156, for each user device landmark extracted from the user device image data. Then, in step 430, the process 150 populates each entry created in step 428. Each entry is populated with at least the user device landmark.

Then, in step 432, the method waits for a time period before accessing another frame of image data. In one example, the delay is 500 milliseconds. However, in other examples, the delay can also be as small as 50 milliseconds, or be on the order of seconds. The method then transitions to step 422 to access the next frame of user device image data from the user device interface 33.

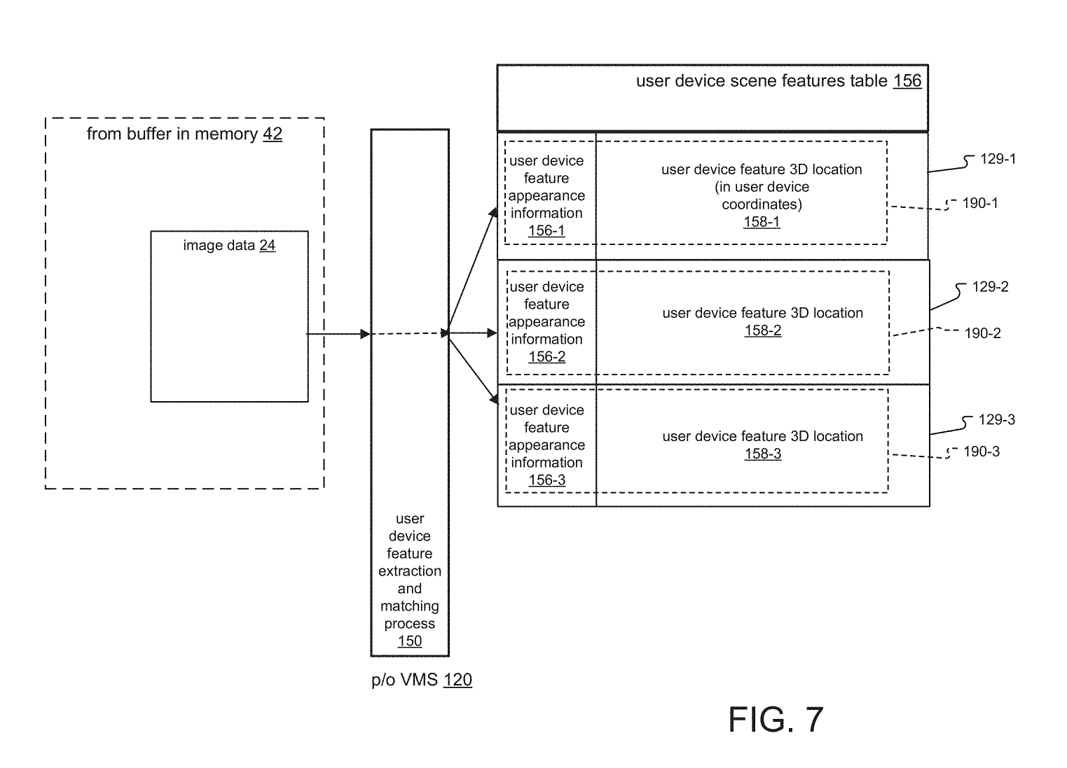

FIG. 7 illustrates how the user device feature extraction and matching process 150 creates entries 129 within the user device scene features table 156. Each entry 129 includes at least user device landmarks 190 that were identified and extracted via the method of FIG. 6.

In more detail, each entry 129 includes fields such as user device feature appearance information 156, and user device feature 3D location 158. The user device feature 3D location 158 is expressed in user device coordinates, such as in world coordinates. The pair of (user device feature appearance information 156, user device feature 3D location 158) for each entry 129 forms a user device landmark 190.

In the illustrated example, the process 150 is shown accessing the buffer in memory 42 to obtain an exemplary frame of image data 24 of the user device 200. In accordance with the method of FIG. 6, the process 150 creates entries 129 in the user device scene features table 156. Exemplary entries 129-1 and 129-2 are shown.

Here, the user device feature extraction and matching process 150 has identified and extracted two separate user device landmarks 190-1 and 190-2 from the image data 24. In one example, entry 129-1 includes user device feature appearance information 156-1 and user device feature 3D location 158-1.

FIG. 8 shows a method of the VMS 120 for creating camera-specific transformation matrices. On the user device 200, the transformation matrices provide a mapping from image data received from the surveillance cameras 110, 112, expressed in a coordinate system of the cameras, to a coordinate system of the user device 200.

In one implementation, the system 100 streamlines this mapping procedure, even allowing it to occur in a passive and continuous fashion that is transparent to the user. The system 100 uses a set of visual feature matches accumulated over time, in order to calculate estimated transformation matrices between each in a set of surveillance cameras and the coordinate system used by the AR device(s). Furthermore, the landmarks used to estimate these transformation matrices can be updated and used to assess the current accuracy of the corresponding, previously-computed transformation matrices.

The method begins in step 500.

In step 500, the user device feature extraction and matching process 150 accesses entries 129 in the user device scene features table 156. In one example, the entries 129 are populated as a user such as an installer traverses the 3D space of a scene 30.

In step 502, the controller 40 instructs the process 150 to compare a user device landmark 190 from the user device scene features table 156, to the camera landmarks 90 within the camera scene features table 146. In this way, features extracted from the AR device's current view will be matched against the landmarks extracted from the unmapped surveillance cameras 110, 112.

According to step 504, the process 150 determines whether one or more matches are found. Each time a match is determined, in step 508, the entry of that camera's landmark 60 within the camera scene features table 146 is annotated with the match score 60 (reflecting its accuracy), match score timestamp 62, and the position (i.e. feature translated 3D location 64). The feature translated 3D location 64 is expressed in coordinates of the coordinate frame/coordinate system of the user device 200. If a landmark has previously been annotated with a recent match of lower quality than the current match, or if the previous match is too old, then it can be supplanted by a new match record.

If a match between a user device landmark 190 and a camera landmark 90 was not found in step 504, the method transitions to step 506. In step 506, the method accesses the next user device landmark 190, and the method transitions back to step 502 to execute another match.

In step 510, the user device feature extraction and matching process 150 determines whether a threshold number of a surveillance camera's landmarks 90 have been matched. If the threshold number of matches have been met, the method transitions to step 514. Otherwise, the method transitions to step 512.

According to step 512, the method determines whether other stored camera landmarks exist for image data of other surveillance cameras. If other camera landmarks 90 exist, the method transitions to step 502 to execute another match. Otherwise, if no more camera landmarks 90 exist, the method transitions back to step 500.

According to step 514, now that the threshold number of matches have been met, the method computes a camera-specific 3D transformation matrix that provides a mapping between the coordinate system of the camera that captured the image data and the coordinate system of the AR device 200. Since homogeneous coordinates are typically used for such purposes, four (4) is the absolute minimum number of points needed within a camera-specific 3D transformation matrix. These points must not be co-planar. A better estimate is made using more points.

The 3D transformation matrix includes 3D locations from the matching landmarks, where the 3D locations are expressed in a coordinate system of the camera (e.g. the feature 3D location 58) and in corresponding 3D locations expressed in a coordinate system of the user device (e.g. the feature translated 3D location 64).

When creating the 3D transformation matrix for a camera, the quality of the estimate is gauged by measuring the difference between the transformed landmark positions, represented by the feature translated 3D locations 64, and the positions observed by the AR device, represented by the user device feature 3D locations 158. The need to judge the quality of the estimate increases the minimum number of points in the 3D transformation matrix to at least 1 more than the number required for a unique solution. Once a good estimate is found, it can be saved and subsequently used to transform the 3D imagery observed by the corresponding surveillance camera, in order to compute visibility by the AR device 200, and for rendering on the AR device 200.

Then, in step 516, the method generates a 3D point cloud for each frame of image data having one or more matching landmarks. In step 518, the playback process 148 sends image data for the camera having the matched landmarks, in conjunction with the 3D transformation matrix for the camera, to the user device 200. At the user device 200, the 3D transformation matrix for a camera enables rendering of the previously captured image data of the scene 30 from that camera to be from a perspective of the user device.

In another embodiment, the user devices 200 can create the camera-specific transformation matrices without the VMS 120. In this embodiment, the user devices 200 have sufficient processing power and memory such that they can receive image data sent directly from the cameras, and create the transformation matrices. For this purpose, in one example, the user devices 200 have similar functionality and components as that shown in FIG. 2 for the VMS 120 and provide methods of operation similar to that of the VMS 120 shown in FIG. 3 through FIG. 8.

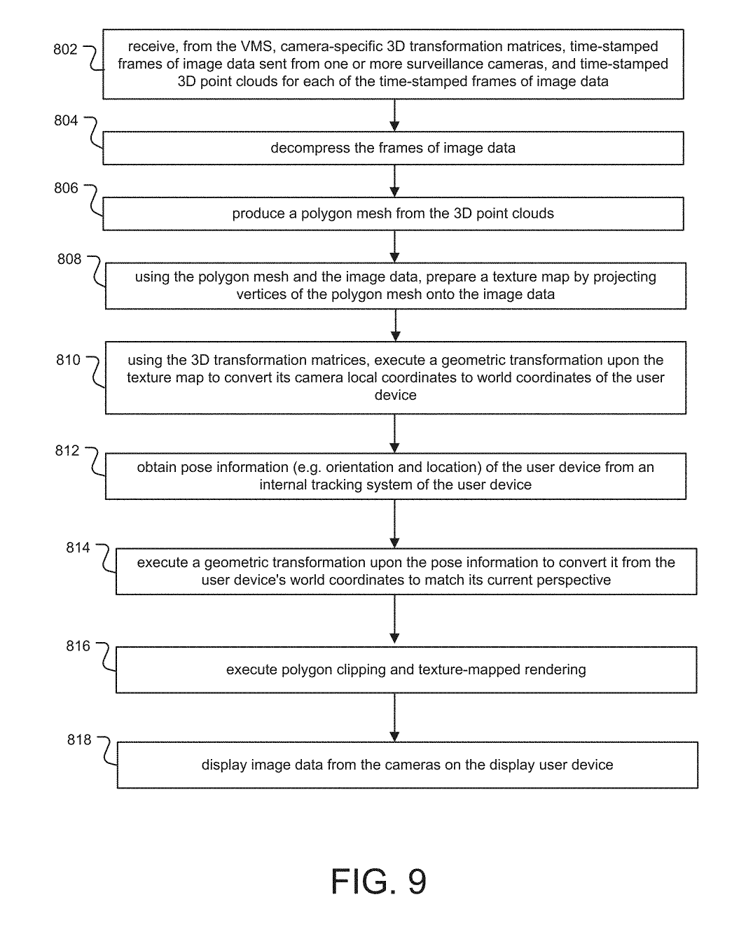

FIG. 9 shows a method for a rendering pipeline executing on the AR device 200.

According to step 802, video frames of time-stamped image data, corresponding time-stamped point clouds for each of the frames of time-stamped image data, and camera-specific 3D transformation matrices are received from the VMS. In step 804, the method decompresses the frames of image data.

In step 806, the method produces a polygon mesh from the 3D point clouds. A process to visualize this might first fit surface geometry to the point cloud, producing the polygon mesh as a result. In step 808, using the polygon mesh and the image data, the method prepares a texture map by projecting the vertices of the polygon mesh onto the corresponding video frame, in order to obtain the corresponding texture coordinate of each.

In step 810, using the 3D transformation matrices, the method executes a geometric transformation upon the texture map to convert its camera local coordinates to coordinates of the AR device's world coordinate system. In step 812, the method obtains pose (e.g. orientation and location) of the user device 200 from an internal tracking system of the user device 200.

Next, in step 814, the method executes a geometric transformation upon the pose information to convert it from the user device's world coordinates to match its current perspective.

In step 816, the method executes polygon clipping and texture-based rendering. These polygons are clipped by the viewing frustum of the AR device and visualized using a texture-mapping renderer.

Finally, in step 818, the method displays image data from the cameras on the display 201 of the user device 200. In one example, the user device 200 creates composite image data by overlaying the captured image data of the scene from the cameras upon the image data of the scene captured by the user device, and then displays the composite image data on the display 201 of the user device 200.

It should be noted that the texture lookup must compensate for the perspective distortion present in the current frames of image data that originated from the surveillance cameras 10, 20.

Further note that it is not necessary for all of a camera's matched landmarks 90 to be visible by the AR device 200 within any single frame captured from it. This is important, since the range of AR devices' depth sensors is often limited. Also, it saves the user the trouble of having to try to match each fixed surveillance camera's view to that of the AR device 200.

Another noteworthy detail is that a given feature seen by the AR device 200 may match landmarks of multiple different cameras. This can happen if the same user device landmark 190 is seen by them (i.e. in the case of camera overlap). However, if matching accuracy is low, then it might make sense even to allow matches with multiple landmarks from the same camera.

Finally, the system can periodically check whether a mapped surveillance camera's 3D transformation matrix is still accurate, by re-computing its camera landmarks 90 and checking whether the new the local positions/feature 3D locations 58 of the camera landmarks 90 still can be accurately transformed to match the observations previously made by the AR device. If not, then the camera can be reverted to unmapped status. Depending on the degree of error, its subsequent imagery might or might not be excluded from visualization.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for displaying video of a scene, the method comprising:
a user device capturing image data of the scene;
a video management system (VMS) providing image data of the scene captured by one or more surveillance cameras; and
the user device rendering the captured image data of the scene from the one or more surveillance cameras to be from a perspective of the user device.

2. The method of claim 1, further comprising the user device obtaining depth information of the scene and sending the depth information to the VMS.

3. The method of claim 1, further comprising the user device creating composite image data by overlaying the captured image data of the scene from the cameras upon the image data of the scene captured by the user device, and then displaying the composite image data on a display of the user device.

4. The method of claim 1, further comprising creating a transformation matrix for each of the cameras, the transformation matrices enabling rendering of the captured image data of the scene from the one or more surveillance cameras to be from a perspective of the user device.

5. The method of claim 4, wherein a transformation matrix for each of the cameras is created by the VMS.

6. The method of claim 4, further comprising transforming the captured image data of the scene from the cameras on the user device.

7. The method of claim 4, wherein creating a transformation matrix for each camera comprises:
receiving image data captured by the user device;
extracting landmarks from the user device image data to obtain user device landmarks, and extracting landmarks from the image data from each camera to obtain camera landmarks for each camera;
comparing the user device landmarks against the camera landmarks for each camera to determine matching landmarks for each camera; and
using the matching landmarks for each camera to create the transformation matrix for each camera.

8. The method of claim 7, further comprising the transformation matrix for each camera including at least four points.

9. The method of claim 7, wherein using the matching landmarks for each camera to create the transformation matrix for each camera comprises:
determining a threshold number of matching landmarks; and
populating the transformation matrix with 3D locations from the matching landmarks, the 3D locations being expressed in a coordinate system of the camera and in corresponding 3D locations expressed in a coordinate system of the user device.

10. The method of claim 1, further comprising the user device being a Tango tablet.

11. A system for displaying video of a scene, the system comprising:
a user device that captures image data of the scene; and
one or more surveillance cameras that capture image data from the scene;
wherein the user device renders the captured image data of the scene from the one or more surveillance cameras to be from a perspective of the user device.

12. The system of claim 1, further comprising a video management system (VMS) that provides the image data of the scene captured by the cameras to the user device.

13. The system of claim 11, wherein the user device includes a depth information sensor that obtains depth information of the scene.

14. The system of claim 11, wherein the user device creates composite image data by overlaying the captured image data of the scene from the cameras upon the image data of the scene captured by the user device, and then displays the composite image data on a display of the user device.

15. The system of claim 1, further comprising a VMS that creates a transformation matrix for each of the cameras, wherein the transformation matrices enable rendering of the captured image data of the scene from the one or more surveillance cameras to be from a perspective of the user device.

16. The system of claim 15, wherein the transformation matrix for each of the cameras provides a mapping between coordinate systems of each of the cameras and a coordinate system of the user device.
